(19) United States
(12) Patent Application Publication
(10) Pub. No.: US 2021/0123947 A1
(43) Pub. Date: Apr. 29, 2021

(54) INERTIAL MEASUREMENT APPARATUS, ELECTRONIC INSTRUMENT, AND MOVING OBJECT

(71) Applicant: Seiko Epson Corporation, Tokyo (JP)

(72) Inventor: Ryohei OZAWA, Chino (JP)

(21) Appl. No.: 17/080,986

(22) Filed: Oct. 27, 2020

(30) Foreign Application Priority Data
Oct. 28, 2019 (JP) 2019-195075

(51) Int. Cl. G01P 15/18; G01P 3/48; G01P 15/097; G01P 15/125

(52) U.S. Cl. CPC G01P 15/18; G01P 15/125; G01P 15/097; G01P 3/48

(57) ABSTRACT

An inertial measurement apparatus includes a substrate, an inertial sensor disposed on a first surface of the substrate, a lid that covers the inertial sensor and is bonded to the substrate, and a terminal disposed on the substrate and bonded to a mounting target object. The inertial sensor does not overlap with a terminal connection section that is a portion where the terminal is coupled to the substrate, and the inertial sensor is shifted from the terminal connection section toward the center of the substrate in the plan view along the thickness direction of the substrate.

The present application is based on, and claims priority from JP Application Serial Number 2019-195075, filed Oct. 28, 2019, the disclosure of which is hereby incorporated by reference herein in its entirety.

### BACKGROUND

### 1. Technical Field

The present disclosure relates to an inertial measurement apparatus, an electronic instrument, and a moving object.

### 2. Related Art

JP-A-2016-138774 describes a sensor apparatus including a substrate, an inertial sensor provided on the upper surface of the substrate, a protective substrate that covers the inertial sensor and is bonded to the upper surface of the substrate, a wiring section that is disposed on the lower surface of the substrate and electrically coupled to the inertial sensor via through electrodes passing through the substrate, and an electrode section that serves as terminals provided at the wiring section.

However, in the sensor apparatus described in JP-A-2016-138774, in which the electrode section and the inertial sensor overlap with each other in the plan view, that is, the inertial sensor is located immediately above the electrode section, stress is likely to be transmitted to the inertial sensor via the electrode section. The characteristics of the inertial sensor are therefore undesirably likely to deteriorate due to the stress.

### SUMMARY

An aspect of the present disclosure is directed to an inertial measurement apparatus including a substrate, an inertial sensor disposed on a first surface of the substrate, a lid that covers the inertial sensor and is bonded to the substrate, and a terminal disposed on the substrate and bonded to a mounting target object. The inertial sensor does not overlap with a terminal connection section that is a portion where the terminal is coupled to the substrate, and the inertial sensor is shifted from the terminal connection section toward a center of the substrate in a plan view along a thickness direction of the substrate.

In the aspect of the present disclosure, the substrate may have a groove disposed between the inertial sensor and the terminal connection section in the plan view.

In the aspect of the present disclosure, the groove may have a shape of a frame that surrounds the inertial sensor in the plan view.

In the aspect of the present disclosure, the groove may open via the first surface.

In the aspect of the present disclosure, the terminal may be disposed on a second surface opposite the first surface, and the groove may open via the second surface.

In the aspect of the present disclosure, the terminal may be disposed on a second surface opposite the first surface, and the groove may include the first groove that opens via the first surface and a second groove that opens via the second surface.

In the aspect of the present disclosure, a lid bonding section that is a portion where the lid is bonded to the substrate may be located between the terminal connection section and the inertial sensor in the plan view.

In the aspect of the present disclosure, the groove may be shifted from the lid bonding section toward the center of the substrate in the plan view.

In the aspect of the present disclosure, the substrate may have a through hole that is so disposed as to be shifted from a space between the inertial sensor and the terminal connection section in the plan view and passes through the substrate in the thickness direction thereof.

In the aspect of the present disclosure, the lid may have fixed potential.

In the aspect of the present disclosure, the terminal may be a lead that extends from the substrate.

Another aspect of the present disclosure is directed to an electronic instrument including the inertial measurement apparatus described above and a signal processing circuit that performs signal processing based on a signal outputted from the inertial measurement apparatus.

Another aspect of the present disclosure is directed to a moving object including the inertial measurement apparatus described above and a signal processing circuit that performs signal processing based on a signal outputted from the inertial measurement apparatus.

### BRIEF DESCRIPTION OF THE DRAWINGS

FIG. 1 is a plan view showing an inertial measurement apparatus according to a first embodiment.

FIG. 2 is a cross-sectional view taken along the line A-A in FIG. 1.

FIG. 3 is a plan view showing a variation of the inertial measurement apparatus shown in FIG. 1.

FIG. 4 is a cross-sectional view showing an inertial measurement apparatus according to a second embodiment.

FIG. 5 is a plan view showing an inertial measurement apparatus according to a third embodiment.

FIG. 6 is a cross-sectional view taken along the line B-B in FIG. 5.

FIG. 7 is a plan view showing an inertial measurement apparatus according to a fourth embodiment.

FIG. 8 is a perspective view showing a smartphone according to a fifth embodiment.

FIG. 9 is a perspective view showing a moving object according to a sixth embodiment.

### DESCRIPTION OF EXEMPLARY EMBODIMENTS

An inertial measurement apparatus, an electronic instrument, and a moving object according to an aspect of the present disclosure will be described below in detail based on embodiments shown in the accompanying drawings.

### First Embodiment

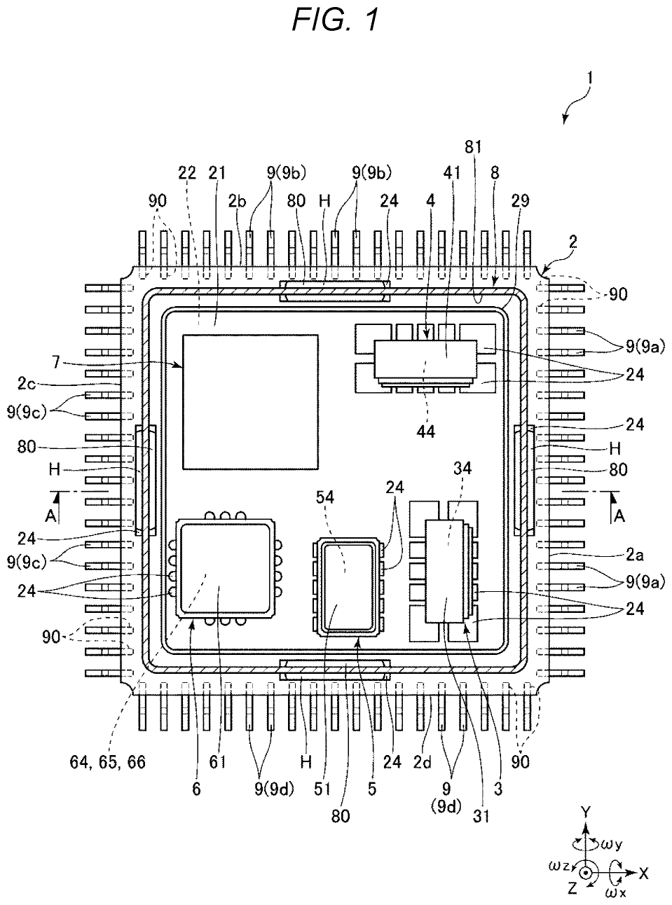

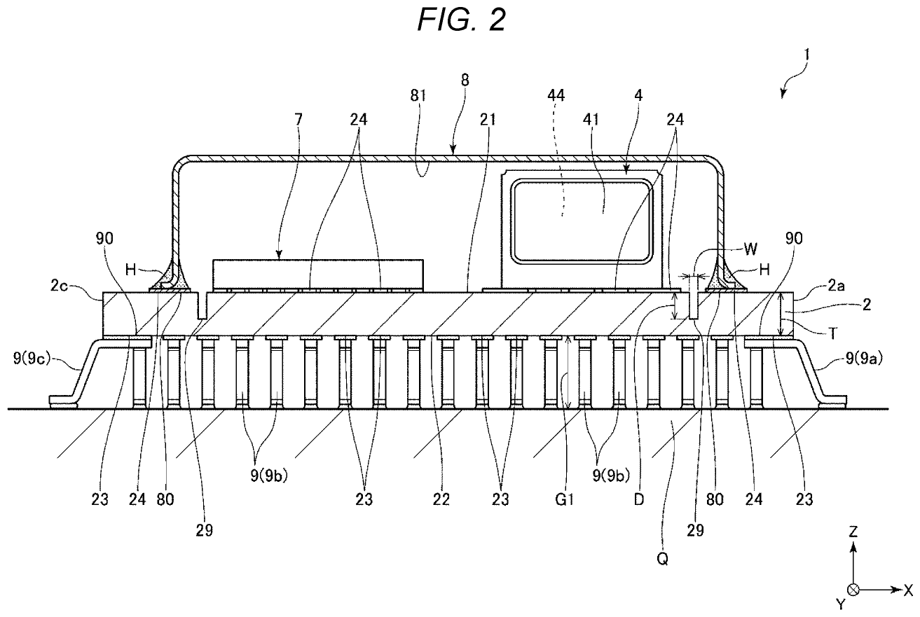

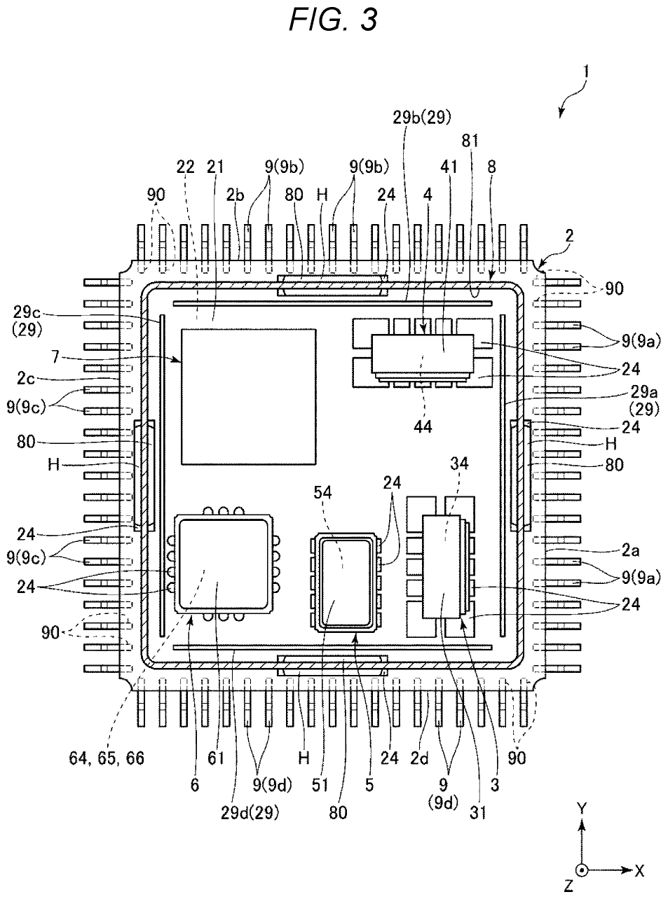

FIG. 1 is a plan view showing an inertial measurement apparatus according to a first embodiment. FIG. 2 is a cross-sectional view taken along the line A-A in FIG. 1. FIG. 3 is a plan view showing a variation of the inertial measurement apparatus shown in FIG. 1. FIGS. 1 to 3 show three axes perpendicular to one another in the form of axes X, Y, and Z for convenience of the description. The direction parallel to the axis X is also called an “X-axis direction,” the direction parallel to the axis Y is also called a “Y-axis direction,” and the direction parallel to the axis Z is also called a “Z-axis direction.” The positive side of the Z-axis direction is also called “upper,” and the negative side of the Z-axis direction is also called “lower.”

The inertial measurement apparatus 1 includes a substrate 2, which has an upper surface 21 as a first surface and a lower surface 22 as a second surface with the upper surface 21 and the lower surface 22 facing away from each other, four inertial sensors 3, 4, 5, and 6 and a circuit device 7 disposed on the upper surface 21 of the substrate 2, a lid 8, which covers the inertial sensors 3, 4, 5, and 6 and the circuit device 7 and is bonded to the upper surface 21 of the substrate 2, and a plurality of leads 9, which are disposed on the lower surface 22 of the substrate 2 and extend as terminals from the substrate 2. The thus configured inertial measurement apparatus 1 is mounted on a mounting target object Q via the plurality of leads 9, and the substrate 2 floats above the mounting target object Q when the inertial measurement apparatus 1 is mounted on the mounting target object Q, as shown in FIG. 2. That is, a gap G1 is formed between the mounting target object Q and the substrate 2. Stress is therefore unlikely to be transmitted from the mounting target object Q to the substrate 2, whereby the characteristics of the inertial measurement apparatus 1 are stabilized.

The substrate 2 has a substantially square shape in the plan view along the Z-axis direction. The thus shaped substrate 2 supports the inertial sensors 3, 4, 5, and 6, the circuit device 7, and the plurality of leads 9 and electrically couples the inertial sensors 3, 4, 5, and 6 and the circuit device 7 to the plurality of leads 9. The substrate 2 is a printed substrate and can, for example, be an epoxy substrate, a glass substrate, a glass-epoxy substrate, or a ceramic substrate. The substrate 2 includes terminals 23, which are disposed on the lower surface 22 and electrically coupled to the leads 9, terminals 24, which are disposed on the upper surface 21 and electrically coupled to the inertial sensors 3, 4, 5, and 6 and the circuit device 7, and internal wiring that is not shown but electrically couples the terminals 23 and 24 to each other, and the substrate 2 electrically couples the inertial sensors 3, 4, 5, and 6 and the circuit device 7 to the plurality of leads 9 via the wiring, as shown in FIGS. 1 and 2.

The inertial sensors 3, 4, 5, and 6 function as follows: The inertial sensor 3 is an X-axis angular velocity sensor that detects angular velocity around the axis X; the inertial sensor 4 is a Y-axis angular velocity sensor that detects angular velocity around the axis Y; the inertial sensor 5 is a Z-axis angular velocity sensor that detects angular velocity around the axis Z; and the inertial sensor 6 is a three-axis acceleration sensor that detects acceleration in the X-axis direction, acceleration in the Y-axis direction, and acceleration in the Z-axis direction independently of one another. That is, the inertial measurement apparatus 1 according to the present embodiment is a six-axis compound sensor. The configuration of the inertial measurement apparatus 1 is, however, not limited to the configuration described above, and at least one of the inertial sensors 3, 4, 5, and 6 may be omitted, or another electronic part may be added.

The inertial sensors 3, 4, and 5 will next be described. The inertial sensors 3, 4, and 5 have the same configuration and are so disposed as to incline with respect to each other by 90° in such a way that the attitude thereof corresponds to the detection axes thereof.

The inertial sensor 3 includes a package 31 and a sensor device 34 accommodated in the package 31, as shown in FIG. 1. Similarly, the inertial sensor 4 includes a package 41 and a sensor device 44 accommodated in the package 41, and the inertial sensor 5 includes a package 51 and a sensor device 54 accommodated in the package 51. The sensor devices 34, 44, and 54 are each, for example, a quartz vibrator having drive arms and detection arms. When angular velocity acts on any of the sensor devices 34, 44, and 54 with the drive arms driven and therefore vibrating, Coriolis force excites the detection arms to cause them to undergo detection vibration, and the angular velocity can be determined based on electric charge produced at the detection arms by the detection vibration. The thus configured inertial sensors 3, 4, and 5 are bonded to the upper surface 21 of the substrate 2 via solder that is not shown and electrically coupled to the corresponding terminals 24.

The inertial sensors 3, 4, and 5 do not necessarily have a specific configuration as long as they can provide the functions thereof. For example, the sensor devices 34, 44, and 54 are each not limited to a quartz vibrator and may, for example, each be a silicon structure and have a configuration that detects angular velocity based on a change in capacitance. In the present embodiment, the sensor devices 34, 44, and 54 have the same configuration, but not necessarily, and at least one of the inertial sensors 3, 4, and 5 may have a configuration different from the configuration of the others. The inertial sensor 3 may have a configuration that allows detection of angular velocity not only around the axis X but around the other axes, such as the axes Y and Z. For example, when the inertial sensor 3 can detect angular velocity around the axes X and Y, the inertial sensor 4 can be omitted, and when the inertial sensor 3 can detect angular velocity around the axes X, Y, and Z, the inertial sensors 4 and 5 can be omitted.

The inertial sensor 6 includes a package 61 and three sensor devices 64, 65, and 66 accommodated in the package 61. The sensor device 64 is a device that detects acceleration in the X-axis direction, the sensor device 65 is a device that detects acceleration in the Y-axis direction, and the sensor device 66 is a device that detects acceleration in the Z-axis direction. The sensor devices 64, 65, and 66 are each a silicon structure including a fixed electrode and a movable electrode that forms capacitance therebetween with the movable electrode and is displaced relative to the fixed electrode upon reception of acceleration in the direction of the detection axis of the sensor device. In this case, acceleration in the X-axis direction can be detected based on a change in the capacitance of the sensor device 64, acceleration in the Y-axis direction can be detected based on a change in the capacitance of the sensor device 65, and acceleration in the Z-axis direction can be detected based on a change in the capacitance of the sensor device 66. The thus configured inertial sensor 6 is bonded to the upper surface 21 of the substrate 2 via solder that is not shown and electrically coupled to the corresponding terminals 24.

The inertial sensor 6 does not necessarily have a specific configuration as long as it can provide the function thereof. For example, the sensor devices 64, 65, and 66 are each not limited to a silicon structure and may, for example, each be a quartz vibrator and have a configuration that detects acceleration based on a change in electric charge produced by the vibration. The sensor devices 64, 65, and 66 may be accommodated in separate packages.

The circuit device 7 includes a drive/detection circuit that drives the inertial sensor 3 and detects angular velocity around the axis X that acts on the inertial sensor 3, a drive/detection circuit that drives the inertial sensor 4 and detects angular velocity around the axis Y that acts on the inertial sensor 4, a drive/detection circuit that drives the inertial sensor 5 and detects angular velocity around the axis Z that acts on the inertial sensor 5, and a drive/detection circuit that drives the inertial sensor 6 and detects acceleration in the axes X, Y, and Z that acts on the inertial sensor 6. The thus configured circuit device 7 is bonded to the upper surface 21 of the substrate 2 via solder that is not shown and electrically coupled to the corresponding terminals 24.

The lid 8 will next be described. The lid 8 has a recess 81, which opens downward, and is bonded to the upper surface 21 of the substrate 2 via solder H with the inertial sensors 3, 4, 5, and 6 and the circuit device 7 accommodated in the recess 81, as shown in FIGS. 1 and 2. The lid 8 is electrically conductive and electrically coupled to the terminals 24 via the solder H. When the inertial measurement apparatus 1 is driven, the lid 8 is coupled to fixed potential, grounded in the present embodiment, via the terminals 24. The lid 8 thus functions as a shield that blocks turbulence to stabilize the characteristics of the inertial sensors 3, 4, 5, and 6 and the circuit device 7. The lid 8 is not necessarily made of a specific material and can be made of any of a variety of metal materials. The lid 8 is made of SUS (stainless steel) in the present embodiment and may instead be made of aluminum, copper, or any other metal material.

The lid 8 has a substantially square shape slightly smaller than the substrate 2 in the plan view along the Z-axis direction, and longitudinal central portions of the edges of the lid 8, that is, lower portions of the four sidewalls of the lid 8 are bonded to the upper surface 21 of the substrate 2 via the solder H, as shown in FIG. 1. That is, the entire circumference of the lower surface of the lid 8 is not bonded to the substrate 2, but the lid 8 has portions that are not bonded to the substrate 2. The portions that are not bonded to the substrate 2, particularly, corner portions of the lid 8, that is, lower ends of the portions where adjacent sidewalls intersect each other are separate from the upper surface 21 of the substrate 2. That is, a gap is formed between the lid 8 and the substrate 2 at each of the corner portions of the lower surface of the lid 8. The inner space of the lid 8 is therefore not sealed but communicates with the space outside the lid 8, whereby heat is unlikely to stay in the inner space of the lid 8. Therefore, for example, heat generated when the inertial measurement apparatus 1 is mounted on the mounting target object Q is unlikely to stay in the inertial measurement apparatus 1, whereby thermal damage on the inertial measurement apparatus 1 can be reduced.

The plurality of leads 9 will next be described. The plurality of leads 9 are bonded to an outer edge section of the lower surface 22 of the substrate 2 via solder that is not shown and electrically coupled to the terminals 23, as shown in FIG. 1. The plurality of leads 9 are disposed along the entire circumference of the outer edge section of the substrate 2. That is, the plurality of leads 9 includes a plurality of leads 9a, which are so disposed as to be separate from each other by a predetermined distance along the longitudinal direction of a first outer edge section 2a of the substrate 2, a plurality of leads 9b, which are so disposed as to be separate from each other by the predetermined distance along the longitudinal direction of a second outer edge section 2b of the substrate 2, a plurality of leads 9c, which are so disposed as to be separate from each other by the predetermined distance along the longitudinal direction of a third outer edge section 2c of the substrate 2, and a plurality of leads 9d, which are so disposed as to be separate from each other by the predetermined distance along the longitudinal direction of a fourth outer edge section 2d of the substrate 2. The arrangement of the leads 9 is, however, not limited to a specific arrangement.

The plurality of leads 9 extend from the outer edge section of the substrate 2 outward from the substrate 2 and bend in the middle of the leads downward, that is, toward the negative side of the Z-axis direction, as shown in FIG. 2. The thus shaped leads 9 allow the substrate 2 to be readily so placed as to be separate upward from the upper surface of the mounting target object Q when the inertial measurement apparatus 1 is mounted on the mounting target object Q via the leads 9.

The basic configuration of the inertial measurement apparatus 1 has been briefly described above. The arrangement of the portions of the inertial measurement apparatus 1 will be described below in detail. The inertial sensors 3, 4, 5, and 6 and the circuit device 7 are so located as not to overlap with terminal connection sections 90, which are the portions where the leads 9 are coupled to the substrate 2, in the plan view along the Z-axis direction and shifted from the terminal connection sections 90 toward the center of the substrate 2, as shown in FIG. 1. The arrangement described above allows the inertial sensors 3, 4, 5, and 6 and the circuit device 7 to be separate from the terminal connection sections 90, whereby turbulence transmitted from the mounting target object Q to the substrate 2 via the leads 9, for example, is sufficiently attenuated before the turbulence reaches the inertial sensors 3, 4, 5, and 6 and the circuit device 7, and the turbulence is therefore unlikely to be transmitted to the inertial sensor 3, 4, 5, or 6 or the circuit device 7. The characteristics of the inertial sensors 3, 4, 5, and 6 and the circuit device 7 are therefore stabilized, whereby excellent detection accuracy can be provided. Further, the size of the inertial measurement apparatus 1 can be reduced by the arrangement in which the inertial sensors 3, 4, 5, and 6 and the circuit device 7 are shifted from the terminal connection sections 90 toward the center of the substrate 2, that is, inward from the terminal connection sections 90. The “turbulence” described above includes, for example, vibration, heat, and stress induced by the difference in coefficient of linear expansion between the substrate 2 and the mounting target object Q.

The distance by which the inertial sensors 3, 4, 5, and 6 and the circuit device 7 are separate from the terminal connection sections 90 is not limited to a specific value, and it is preferable that the separation distance is, for example, approximately greater than or equal to 1 μm but smaller than or equal to 5 μm. The inertial sensors 3, 4, 5, and 6 and the circuit device 7 can thus be sufficiently separate from the terminal connection sections 90, whereby a remarkable turbulence attenuation effect is provided. The turbulence is therefore more unlikely to be transmitted to the inertial sensor 3, 4, 5, or 6 or the circuit device 7, whereby the characteristics of the inertial sensors 3, 4, 5, and 6 and the circuit device 7 can be further stabilized. Further, an excessive increase in the distance by which the inertial sensors 3, 4, 5, and 6 and the circuit device 7 are separate from the terminal connection sections 90 can be suppressed, whereby an increase in the size of the inertial measurement apparatus 1 can be effectively suppressed.

The substrate 2 has a groove 29 disposed between the inertial sensors 3, 4, 5, and 6/the circuit device 7 and the terminal connection sections 90 in the plan view along the Z-axis direction, as shown in FIGS. 1 and 2. The groove 29 has the function of attenuating the turbulence transmitted from the mounting target object Q to the substrate 2 via the leads 9 before the turbulence is transmitted to the inertial sensors 3, 4, 5, and 6 and the circuit device 7. The thus disposed groove 29 causes the turbulence to be more unlikely to be transmitted to the inertial sensor 3, 4, 5, or 6 or the circuit device 7 and therefore further stabilizes the characteristics of the inertial sensors 3, 4, 5, and 6 and the circuit device 7, whereby more excellent detection accuracy can be provided.

The groove 29 is formed of a bottomed recess that opens via the upper surface 21. That is, the groove 29 is not open via the lower surface 22. The configuration in which the groove 29 opens via the upper surface 21, which is the surface on which the inertial sensors 3, 4, 5, and 6 and the circuit device 7 are disposed, allows the groove 29 to provide a more remarkable turbulence attenuation effect. Further, the configuration in which the groove 29 is not a through hole but is a bottomed recess allows the internal wiring described above to be routed between the bottom surface of the groove 29 and the lower surface 22, whereby the internal wiring, particularly, wiring having one end to be coupled to the terminals 24 is routed with increased flexibility. Moreover, a decrease in the mechanical strength of the substrate 2 can be suppressed.

A depth D of the groove 29 is not limited to a specific value, and it is preferable that the depth D is approximately greater than or equal to one-fourth of a thickness T of the substrate 2 but smaller than or equal to three-fourths of the thickness T, as shown in FIG. 2. That is, it is preferable to satisfy T/4≤D≤3 T/4. The groove 29 is thus sufficiently deep, whereby the turbulence attenuation effect can be more reliably and effectively provided. Further, a situation in which the groove 29 is so deep that the mechanical strength of the substrate 2 lowers or a situation in which the flexibility of the internal wiring routing lowers can be suppressed. A width W of the groove 29 is not limited to a specific value, and it is preferable that the width W is, for example, approximately greater than or equal to 0.5 μm but smaller than or equal to 2 μm. The groove 29 has thus a sufficiently large width W, whereby the turbulence attenuation effect can be more reliably and effectively provided. Further, a situation in which the width W of the groove 29 is so large that the size of the substrate 2 increases can be suppressed.

The groove 29 has the shape of a frame, particularly, a continuous annular frame that surrounds the inertial sensors 3, 4, 5, and 6 and the circuit device 7 in the plan view along the Z-axis direction, as shown in FIG. 1. The configuration in which the frame-shaped groove 29 surrounds the inertial sensors 3, 4, 5, and 6 and the circuit device 7 allows more reliable, effective attenuation of the turbulence transmitted to the substrate 2 via the leads 9 before the turbulence is transmitted to the inertial sensors 3, 4, 5, and 6 and the circuit device 7. In the present embodiment, the groove 29 is a single annular groove and may instead be two or more successive annular grooves.

The groove 29 does not necessarily have a specific configuration and may have any configuration in which the groove 29 is disposed between the inertial sensors 3, 4, 5, 6 and at least one of the leads 9. For example, the groove 29 in a variation shown in FIG. 3 includes a first section 29a, which is located between the leads 9a and the inertial sensors 3, 4, 5, 6 and extends along the Y-axis direction, a second section 29b, which is located between the leads 9b and the inertial sensors 3, 4, 5, 6 and extends along the X-axis direction, a third section 29c, which is located between the leads 9c and the inertial sensors 3, 4, 5, 6 and extends along the Y-axis direction, and a fourth section 29d, which is located between the leads 9d and the inertial sensors 3, 4, 5, 6 and extends along the X-axis direction, and the first section 29a to the fourth section 29d are so formed as to be separate from each other. For example, one, two, or three of the first section 29a to the fourth section 29d may be omitted in the variation shown in FIG. 3.

Lid bonding sections 80, which are portions where the lid 8 is bonded to the substrate 2 via the solder H, are located between the terminal connection sections 90 and the inertial sensors 3, 4, 5, 6/the circuit device 7 in the plan view along the Z-axis direction, as shown in FIG. 1. The configuration in which the lid bonding sections 80 are disposed between the terminal connection sections 90 and the inertial sensors 3, 4, 5, 6/the circuit device 7 as described above allows the turbulence transmitted to the substrate 2 via the leads 9 to be released to the lid 8 via the lid bonding sections 80 before the turbulence is transmitted to the inertial sensors 3, 4, 5, and 6 and the circuit device 7. The turbulence is therefore more unlikely to be transmitted to the inertial sensor 3, 4, 5, or 6 or the circuit device 7.

The groove 29 is shifted from the lid bonding sections 80 toward the center of the substrate 2 in the plan view along the Z-axis direction. Since a portion of the substrate 2 that is the portion inside the lid bonding sections 80 is reinforced by the lid 8, the configuration in which the groove 29 is formed in the portion allows suppression of a decrease in the mechanical strength of the substrate 2 to a small degree. The groove 29 is not necessarily formed as described above and may be shifted from the lid bonding sections 80 toward the outer edge of the substrate 2 in the plan view along the Z-axis direction.

The inertial measurement apparatus 1 has been described. The inertial measurement apparatus 1 includes, as described above, the substrate 2, the inertial sensors 3, 4, 5, and 6, which are disposed on the upper surface 21 of the substrate 2, which is the first surface thereof, the lid 8, which covers the inertial sensors 3, 4, 5, and 6 and is bonded to the substrate 2, and the leads 9, which are disposed on the substrate 2 and serve as the terminals bonded to the mounting target object Q, and the inertial sensor 3, 4, 5, or 6 does not overlap with the terminal connection sections 90, which are the portions where the leads 9 are coupled to the substrate 2, and the inertial sensors 3, 4, 5, and 6 are shifted from the terminal connection sections 90 toward the center of the substrate 2 in the plan view along the thickness direction of the substrate 2, that is, the Z-axis direction. The configuration described above allows sufficient attenuation of the turbulence transmitted from the mounting target object Q to the substrate 2 via the leads 9 before the turbulence reaches the inertial sensors 3, 4, 5, and 6, whereby the turbulence is unlikely to be transmitted to the inertial sensor 3, 4, 5, or 6. The characteristics of the inertial sensors 3, 4, 5, and 6 are therefore stabilized, whereby excellent detection accuracy can be provided. Further, the size of the inertial measurement apparatus 1 can be reduced by the arrangement in which the inertial sensors 3, 4, 5, and 6 are shifted from the terminal connection sections 90 toward the center of the substrate 2, that is, inward from the terminal connection sections 90.

The substrate 2 has the groove 29 disposed between the inertial sensors 3, 4, 5, 6 and the terminal connection sections 90 in the plan view along the Z-axis direction, as described above. The groove 29 has the function of attenuating the turbulence transmitted to the substrate 2 via the leads 9 before the turbulence is transmitted to the inertial sensors 3, 4, 5, and 6. The turbulence is therefore more unlikely to be transmitted to the inertial sensor 3, 4, 5, or 6, whereby the characteristics of the inertial sensors 3, 4, 5, and 6 are further stabilized.

The groove 29 has the shape of a frame that surrounds the inertial sensors 3, 4, 5, and 6 in the plan view along the Z-axis direction, as described above. The configuration in which the frame-shaped groove 29 surrounds the inertial sensors 3, 4, 5, and 6 allows more reliable, effective attenuation of the turbulence transmitted to the substrate 2 via the leads 9 before the turbulence is transmitted to the inertial sensors 3, 4, 5, and 6.

The groove 29 opens via the upper surface 21, as described above. The configuration in which the groove 29 opens via the upper surface 21, which is the surface on which the inertial sensors 3, 4, 5, and 6 are disposed, allows the groove 29 to provide a more remarkable turbulence attenuation effect.

The lid bonding sections 80, which are the portions where the lid 8 is bonded to the substrate 2, are located between the terminal connection sections 90 and the inertial sensors 3, 4, 5, 6 in the plan view along the Z-axis direction, as described above. The configuration described above allows the turbulence transmitted to the substrate 2 via the leads 9 to be released to the lid 8 via the lid bonding sections 80 before the turbulence is transmitted to the inertial sensors 3, 4, 5, and 6. The turbulence is therefore more unlikely to be transmitted to the inertial sensor 3, 4, 5, or 6.

The groove 29 is shifted from the lid bonding sections 80 toward the center of the substrate 2 in the plan view along the Z-axis direction, as described above. Since a portion of the substrate 2 that is the portion inside the lid bonding sections 80 is reinforced by the lid 8, the configuration in which the groove 29 is formed in the portion allows suppression of a decrease in the mechanical strength of the substrate 2 to a small degree.

The lid 8 has fixed potential, as described above. In particular, the lid 8 is grounded in the present embodiment. The lid 8 thus functions as a shield that blocks turbulence to stabilize the characteristics of the inertial sensors 3, 4, 5, and 6.

The terminals are the leads 9, which extend from the substrate 2, as described above. The substrate 2 can thus be readily so supported as to float from the mounting target object Q.

### Second Embodiment

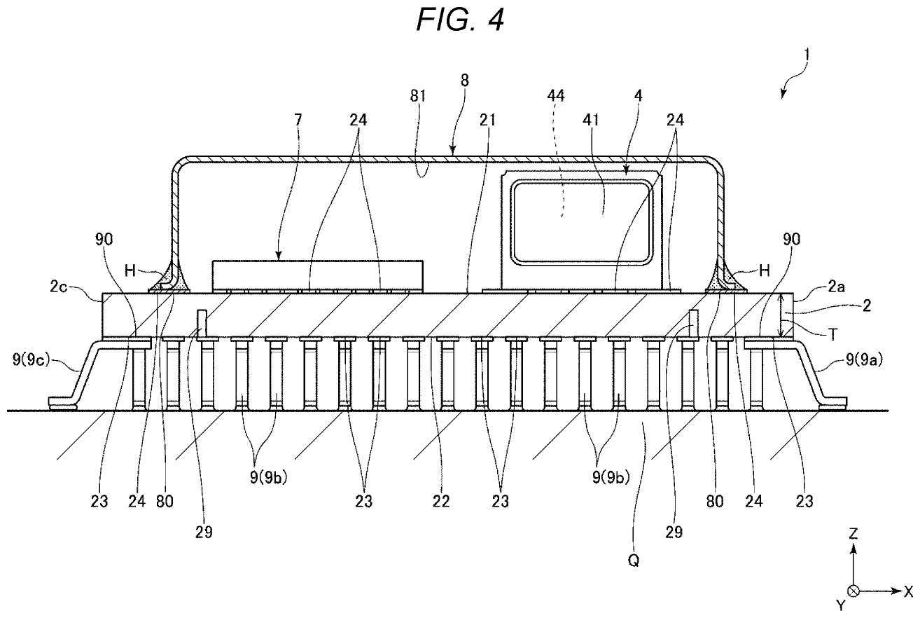

FIG. 4 is a cross-sectional view showing an inertial measurement apparatus according to a second embodiment.

The present embodiment is the same as the first embodiment described above except that the groove 29 is configured differently. The following description of the present embodiment will be primarily made of the difference from the first embodiment described above, and the same items as those in the first embodiment described above will not be described. In FIG. 4, the same configurations as those in the embodiment described above have the same reference characters.

In the inertial measurement apparatus 1 shown in FIG. 4, the groove 29 is formed of a bottomed recess that opens via the lower surface 22. That is, the opening of the groove 29 is located at the surface opposite the surface at which the opening the groove 29 is located in the first embodiment described above. The configuration in which the groove 29 is open via the lower surface 22, which is the surface to which the leads 9 are bonded, allows the groove 29 to effectively attenuate the turbulence transmitted from the mounting target object Q via the leads 9. The depth D, the width W, and other dimensions and the arrangement pattern of the groove 29 can be the same as those described in the first embodiment.

As described above, in the inertial measurement apparatus 1 according to the present embodiment, the leads 9 as the terminals are disposed on the lower surface 22 of the substrate 2, which is the second surface opposite the upper surface 21 of the substrate 2, which is the first surface, and the groove 29 opens via the lower surface 22. The thus formed groove 29 can effectively attenuate the turbulence transmitted via the leads 9.

The thus configured second embodiment can also provide the same effects as those provided by the first embodiment described above.

### Third Embodiment

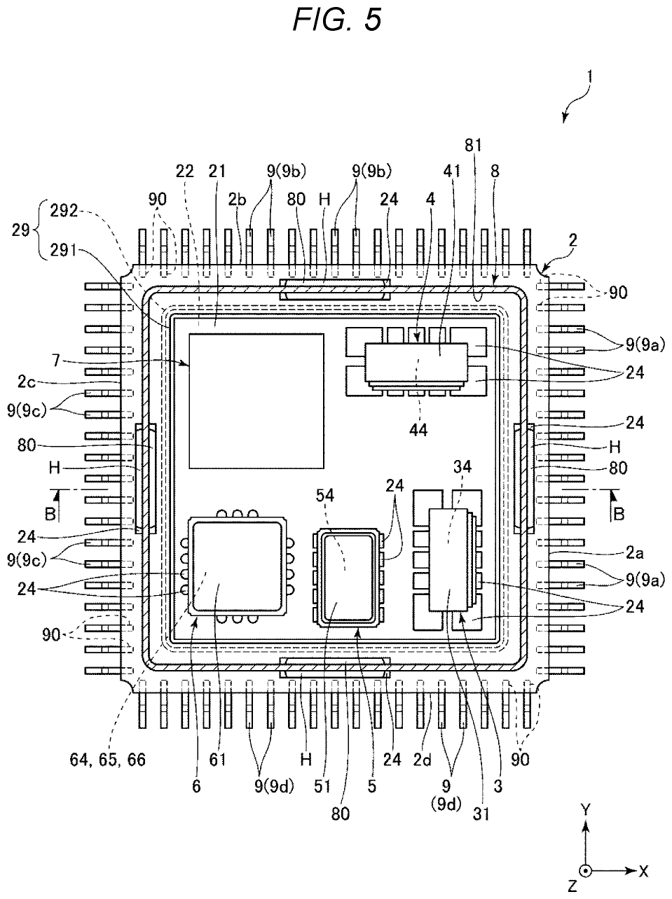

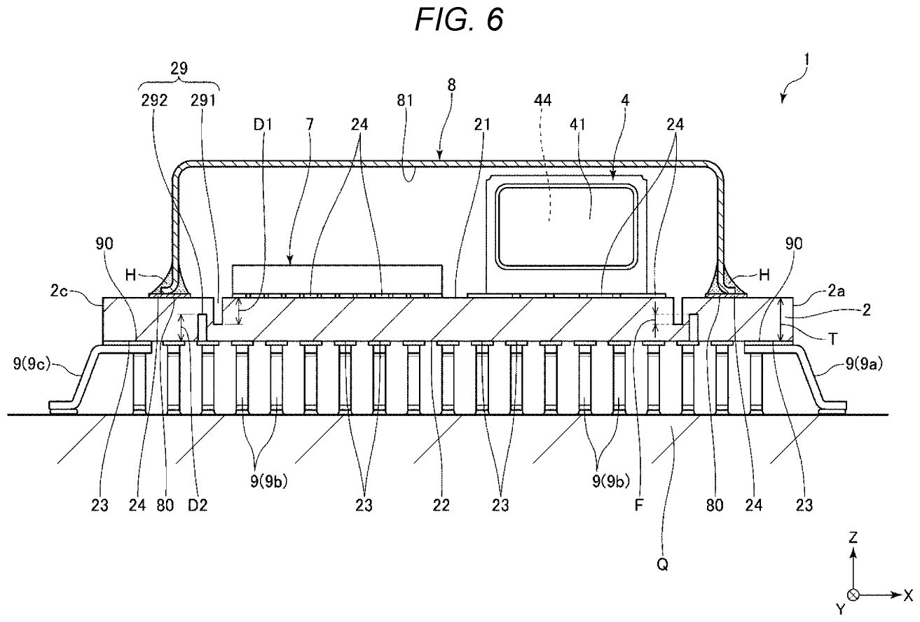

FIG. 5 is a plan view showing an inertial measurement apparatus according to a third embodiment. FIG. 6 is a cross-sectional view taken along the line B-B in FIG. 5.

The present embodiment is the same as the first embodiment described above except that the groove 29 is configured differently. The following description of the present embodiment will be primarily made of the differences from the first and second embodiments described above, and the same items as those in the first and second embodiments described above will not be described. In FIGS. 5 and 6, the same configurations as those in the embodiments described above have the same reference characters.

In the inertial measurement apparatus 1 shown in FIGS. 5 and 6, the groove 29 includes a first groove 291, which is formed of a bottomed recces that opens via the upper surface 21, and a second groove 292, which is formed of a bottomed recces that opens via the lower surface 22. The first groove 291 and the second groove 292 each have the shape of a frame that surrounds the inertial sensors 3, 4, 5, and 6 and the circuit device 7 in the plan view along the Z-axis direction. The first groove 291 and the second groove 292 do not overlap with each other, and the first groove 291 is located on the inner side of the second groove 292 in the plan view along the Z-axis direction in the present embodiment. That is, the groove 29 has a double structure including the frame-shaped first groove 291 and the frame-shaped second groove 292, which surrounds the first groove 291, in the plan view along the Z-axis direction.

The configuration described above in which the first groove 291, which opens via the upper surface 21, which is the surface on which the inertial sensors 3, 4, 5, and 6 and the circuit device 7 are disposed, and the second groove 292, which opens via the lower surface 22, which is the surface to which the leads 9 are bonded, are formed in the substrate 2 allows effective attenuation of the turbulence transmitted from the mounting target object Q via the leads 9. The first groove 291 and the second groove 292 are not necessarily arranged as described above, and the first groove 291 may be located on the outer side of the second groove 292. At least one of the first groove 291 and the second groove 292 may have the pattern shown in FIG. 3.

In the present embodiment, in particular, the sum of a depth D1 of the first groove 291 and a second depth D2 of the second groove 292 is greater than the thickness T of the substrate 2, that is, the relationship D1+D2>T is satisfied, and a section F, where the first groove 291 and the second groove 292 overlap with each other in the side view, is provided, as shown in FIG. 6. The thus configured groove 29 can effectively attenuate the turbulence. The relationship D1+D2>T is not necessarily satisfied, and at least part of the groove 29 may satisfy D1+D2≤T.

As described above, in the inertial measurement apparatus 1 according to the present embodiment, the leads 9 as the terminals are disposed on the lower surface 22, which is the second surface opposite the upper surface 21, which is the first surface, and the groove 29 includes the first groove 291, which opens via the upper surface 21, and the second groove 292, which opens via the lower surface 22. The configuration described above in which the first groove 291, which opens via the upper surface 21, which is the surface on which the inertial sensors 3, 4, 5, and 6 are disposed, and the second groove 292, which opens via the lower surface 22, which is the surface to which the leads 9 are bonded, are formed in the substrate 2 allows effective attenuation of the turbulence transmitted from the mounting target object Q via the leads 9.

The thus configured third embodiment can also provide the same effects as those provided by the first embodiment described above. Unlike the above description, the first groove 291 and the second groove 292 may partially or entirely overlap with each other in the plan view along the Z-axis direction. In this case, the first groove 291 and the second groove 292 do not communicate with each other.

### Fourth Embodiment

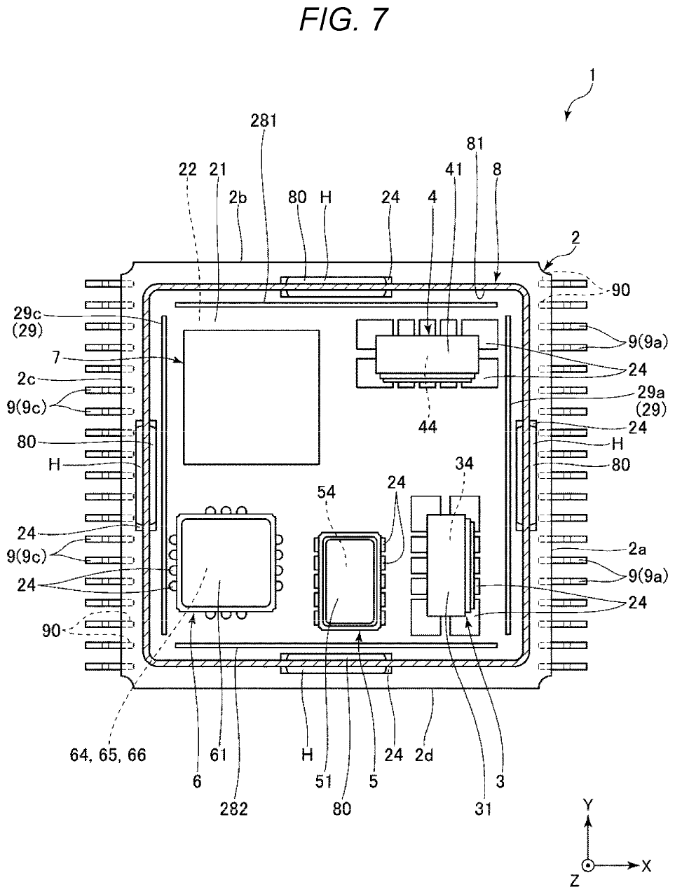

FIG. 7 is a plan view showing an inertial measurement apparatus according to a fourth embodiment.

The present embodiment is the same as the first embodiment described above except that the substrate 2 and the leads 9 are configured differently. The following description of the present embodiment will be primarily made of the differences from the embodiments described above, and the same items as those in the embodiments described above will not be described. In FIG. 7, the same configurations as those in the embodiments described above have the same reference characters.

In the inertial measurement apparatus 1 shown in FIG. 7, the plurality of leads 9 include the plurality of leads 9a, which are disposed along the first outer edge section 2a of the substrate 2, and the plurality of leads 9c, which are disposed along the third outer edge section 2c of the substrate 2. That is, the plurality of leads 9b, which are disposed along the second outer edge section 2b of the substrate 2, and the plurality of leads 9d, which are disposed along the fourth outer edge section 2d of the substrate 2, are omitted in the configuration in the first embodiment described above.

The groove 29 includes the first section 29a, which is located between the leads 9a and the inertial sensors 3, 4, 5, 6/the circuit device 7 and extends along the Y-axis direction, and the third section 29c, which is located between the leads 9c and the inertial sensors 3, 4, 5, 6/the circuit device 7 and extends along the Y-axis direction. That is, the second section 29b and the fourth section 29d may be omitted in the variation shown in FIG. 3 described above.

The substrate 2 further has a through hole 281, which is located between the second outer edge section 2b of the substrate 2 and the inertial sensors 3, 4, 5, 6/the circuit device 7 and extends along the X-axis direction, and a through hole 282, which is located between the fourth outer edge section 2d of the substrate 2 and the inertial sensors 3, 4, 5, 6/the circuit device 7 and extends along the X-axis direction. The through holes 281 and 282 pass through the substrate 2 in the thickness direction thereof and open via the upper surface 21 and the lower surface 22. The thus configured through holes 281 and 282 have the function of attenuating the turbulence transmitted from the mounting target object Q via the leads 9 before the turbulence reaches the inertial sensors 3, 4, 5, and 6 and the circuit device 7, in the case of the groove 29. The through holes 281 and 282 excel in the turbulence attenuation effect as compared with the groove 29 formed of a bottomed recess. The turbulence transmitted from the mounting target object Q via the leads 9 can therefore be effectively attenuated before the turbulence reaches the inertial sensors 3, 4, 5, and 6 and the circuit device 7.

In the present embodiment, in particular, the groove 29 is formed in the area located between the inertial sensors 3, 4, 5, 6/the circuit device 7 and the terminal connection sections 90, and the through holes 281 and 282 are formed in areas shifted from the area between the inertial sensors 3, 4, 5, 6/the circuit device 7 and the terminal connection sections 90. In other words, the groove 29 is formed in the area located between the first outer edge section 2a of the substrate 2, where the terminal connection sections 90 are provided, and the inertial sensors 3, 4, 5, 6/the circuit device 7, and in the area between the third outer edge section 2c of the substrate 2, where the terminal connection sections 90 are provided, and the inertial sensors 3, 4, 5, 6/the circuit device 7, and the through holes 281 and 282 are formed in the area located between the second outer edge section 2b of the substrate 2, where no terminal connection sections 90 are provided, and the inertial sensors 3, 4, 5, 6/the circuit device 7, and in the area located between the fourth outer edge section 2d of the substrate 2, where no terminal connection sections 90 are provided, and the inertial sensors 3, 4, 5, 6/the circuit device 7, respectively. The excellent turbulence attenuation effect described above can therefore be provided with the wiring in the substrate 2, particularly, the wiring that couples the terminals 24 to the inertial sensors 3, 4, 5, and 6 and the circuit device 7 routed with high flexibility.

In the present embodiment, the through holes 281 and 282 are so formed as to separate from the groove 29, but not necessarily. For example, ends of the through holes 281 and 282 that are the ends facing the positive side of the X-axis direction may be coupled to the first section 29a, and ends of the through holes 281 and 282 that are the ends facing the negative side of the X-axis direction may be coupled to the third section 29c. That is, the groove 29 and the through holes 281 and 282 may be coupled to each other in the form of a frame.

As described above, in the inertial measurement apparatus 1 according to the present embodiment, the substrate 2 has the through holes 281 and 282, which are so disposed as to be shifted from the space between the inertial sensors 3, 4, 5, 6 and the terminal connection sections 90 in the plan view along the Z-axis direction and pass through the substrate in the thickness direction thereof. The excellent turbulence attenuation effect can therefore be provided with the wiring in the substrate 2 routed with high flexibility.

The thus configured fourth embodiment can also provide the same effects as those provided by the first embodiment described above.

### Fifth Embodiment

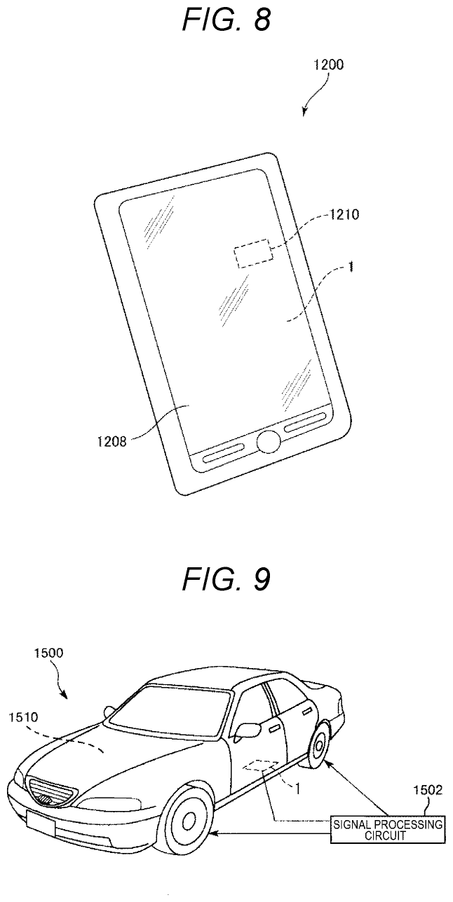

FIG. 8 is a perspective view showing a smartphone according to a fifth embodiment.

A smartphone 1200 as the electronic instrument shown in FIG. 8 accommodates the inertial measurement apparatus 1 and a control circuit 1210, which performs control based on a detection signal outputted from the inertial measurement apparatus 1. Detection data detected by the inertial measurement apparatus 1 is transmitted to the control circuit 1210, and the control circuit 1210 recognizes the attitude and behavior of the smartphone 1200 based on the received detection data and can change an image displayed on a display section 1208, issue an alarm sound or an effect sound, and drive a vibration motor to vibrate the main body of the smartphone 1200.

The thus configured smartphone 1200 as the electronic instrument includes the inertial measurement apparatus 1 and the control circuit 1210, which performs control based on the detection signal outputted from the inertial measurement apparatus 1. The smartphone 1200 can therefore benefit from the above-mentioned effects provided by the inertial measurement apparatus 1 and hence have high reliability.

The electronic instrument is not limited to the smartphone 1200 described above and can, for example, be a personal computer, a digital still camera, a tablet terminal, a timepiece including a smartwatch, an inkjet-type discharge apparatus, for example, an inkjet printer, a wearable terminal, such as a head mounted display (HMD) and smart glasses, a television receiver, a video camcorder, a video tape recorder, a car navigator, a pager, an electronic notepad, an electronic dictionary, an electronic translator, a desktop calculator, an electronic game console, a training instrument, a word processor, a workstation, a TV phone, a security television monitor, electronic binoculars, a POS terminal, a medical instrument, such as an electronic thermometer, a blood pressure gauge, a blood sugar meter, an electrocardiograph, an ultrasonic diagnostic apparatus, and an electronic endoscope, a fish finder, a variety of measuring instruments, a variety of meters incorporated in a vehicle, an airplane, and a ship, a base station for mobile terminals, and a flight simulator.

### Sixth Embodiment

FIG. 9 is a perspective view showing a moving object according to a sixth embodiment.

An automobile 1500 as the moving object shown in FIG. 9 accommodates a system 1510, which is at least any of an engine system, a brake system, and a keyless entry system, the inertial measurement apparatus 1, and a control circuit 1502, and the inertial measurement apparatus 1 can detect the attitude of the vehicle body. The detection signal from the inertial measurement apparatus 1 is supplied to the control circuit 1502, which can control the system 1510 based on the signal.

As described above, the automobile 1500 as the moving object includes the inertial measurement apparatus 1 and the control circuit 1502, which performs control based on the detection signal outputted from the inertial measurement apparatus 1. The automobile 1500 can therefore benefit from the above-mentioned effects provided by the inertial measurement apparatus 1 and hence have high reliability.

The moving object including the inertial measurement apparatus 1 is not limited to the automobile 1500 and may instead, for example, be a robot, a drone, a motorized wheelchair, a motorcycle, an airplane, a helicopter, a ship, a train, a monorail car, a cargo carrier, a rocket, and a spacecraft.

The inertial measurement apparatus, the electronic instrument, and the moving object according to the present disclosure have been described based on the embodiments shown in the drawings, but the present disclosure is not limited to the embodiments, and the configuration of each portion of the inertial measurement apparatus, the electronic instrument, and the moving object can be replaced with a portion having an arbitrary configuration having the same function. Further, another arbitrarily constituent part may be added to the present disclosure.

What is claimed is:

1. An inertial measurement apparatus comprising:
a substrate;
an inertial sensor disposed on a first surface of the substrate;
a lid that covers the inertial sensor and is bonded to the substrate; and
a terminal disposed on the substrate and bonded to a mounting target object,
wherein the inertial sensor does not overlap with a terminal connection section that is a portion where the terminal is coupled to the substrate, and the inertial sensor is shifted from the terminal connection section toward a center of the substrate in a plan view along a thickness direction of the substrate.

2. The inertial measurement apparatus according to claim 1, wherein the substrate has a groove disposed between the inertial sensor and the terminal connection section in the plan view.

3. The inertial measurement apparatus according to claim 2, wherein the groove has a shape of a frame that surrounds the inertial sensor in the plan view.

4. The inertial measurement apparatus according to claim 2, wherein the groove opens via the first surface.

5. The inertial measurement apparatus according to claim 2,
wherein the terminal is disposed on a second surface opposite the first surface, and
the groove opens via the second surface.

6. The inertial measurement apparatus according to claim 2,
wherein the terminal is disposed on a second surface opposite the first surface, and
the groove includes the first groove that opens via the first surface and a second groove that opens via the second surface.

7. The inertial measurement apparatus according to claim 1, wherein a lid bonding section that is a portion where the lid is bonded to the substrate is located between the terminal connection section and the inertial sensor in the plan view.

8. The inertial measurement apparatus according to claim 7, wherein the groove is shifted from the lid bonding section toward the center of the substrate in the plan view.

9. The inertial measurement apparatus according to claim 1, wherein the substrate has a through hole that is so disposed as to be shifted from a space between the inertial sensor and the terminal connection section in the plan view and passes through the substrate in the thickness direction thereof.

10. The inertial measurement apparatus according to claim 1, wherein the lid has fixed potential.

11. The inertial measurement apparatus according to claim 1, wherein the terminal is a lead that extends from the substrate.

12. An electronic instrument comprising:
the inertial measurement apparatus according to claim 1; and
a signal processing circuit that performs signal processing based on a signal outputted from the inertial measurement apparatus.

13. A moving object comprising:
the inertial measurement apparatus according to claim 1; and
a signal processing circuit that performs signal processing based on a signal outputted from the inertial measurement apparatus.
